(19) United States
(12) Patent Application Publication
(10) Pub. No.: US 2005/0084818 A1
(43) Pub. Date: Apr. 21, 2005

(54) Endodontic instrument

(76) Inventor: Steven S. Larsen, North Logan, UT (US)

Correspondence Address: Thompson E. Fehr;Suite 300, Goldenwest Corporate Center, 5025 Adams Avenue, Ogden, UT, 84403, US

(21) Appl. No.: 10/690,421

(22) Filed: Oct. 20, 2003

(51) Int. Cl. A61C 3/00; A61C 5/02

(52) U.S. Cl. 433/141; 433/147; 433/102

(57) ABSTRACT

An endodontic instrument having a handle and a cap. The handle and cap are threadingly mated. A channel extends through a first end of the cap; the second end of the cap contains an aperture through which an endodontic file can project. Optionally, the edodontic instrument includes a bent endodontic file; and the aperture in the second end of the cap is extended to the side of the cap and, on such side, elartged to dimensions sufficient to permit the introduction into the channel of a plastic cap attached to the end of the endodontic file opposite to the tip of the endodontic file.

### BACKGROUND OF THE INVENTION

1. Field of the Invention

This invention relates to endodontic tools, especially a holder for an endodontic file and also to a specially shaped endodontic file for optional use with such holder.

2. Description of the Related Art

Numerous patents have been granted for holding an endodontic file. These include U.S. Pat. Nos. 3,247,594; 4,251,214; 4,330,278; 4,582,489; 4,940,410; 4,992,048; 5,775,903; 5,775,904; 5,921,775; 6,174,165; 6,213,771; 6,231,340; and 6,575,747.

The device of U.S. Pat. No. 3,247,594 describes what has become a traditional cap for an endodontic file.

And U.S. Pat. No. 6,231,340 describes the closest holder to the present invention. The device of that patent has an aperture near an end of an elongated handle. The aperture is transverse to the longitudinal handle. The shaft of a dental tool is placed into the transvers aperture, and a nut is screwed from the end of the handle against such shaft.

U.S. Pat. Nos. 4,992,048 and 5,775,904 show endodontic files that initially move away from the centerline of the file and then curve back parallel to or toward such centerline; but the files of these patents do not cross such centerline. Although the filling device of U.S. Pat. No. 1,818,627 does cross the centerline, it is not a file. It is used for filling a root canal, not filing such a canal to remove material-the opposite of filling.

### BRIEF SUMMARY OF THE INVENTION

The present Endodontic Instrument comprises a handle to which a cap is threadably attached. The cap has a channel extending through a first end of the cap, and a second end of the cap is farther from the handle and contains an aperture through which an endodontic file can project. The aperture has a diameter selected to be larger than the diameter of the endodontic file but small than the diameter of the plastic cap attached to the endodontic file.

Optionally, the Endodontic Instrument includes an endodontic file that initially moves away from the centerline of the endodontic file and then curves back toward and crosses the centerline. In order to accommodate such a bent endodontic file, the aperture is extended to the side of the cap and, on such side, enlarged to dimensions sufficient to permit the introduction of the plastic cap.

### BRIEF DESCRIPTION OF THE SEVERAL VIEWS OF THE DRAWING

FIG. 1 portrays the holder of the Endodontic Instrument.

FIG. 2 illustrates the optional bent endodontic file.

### DETAILED DESCRIPTION OF THE INVENTION

An endodontic file is a small, tapered, fluted wire that is used in preparing and cleaning the root canal of a tooth.

Although the prior art includes the holders discussed above, a dentist usually simply holds with the thumb and the index finger a plastic cap that is attached to the endodontic file.

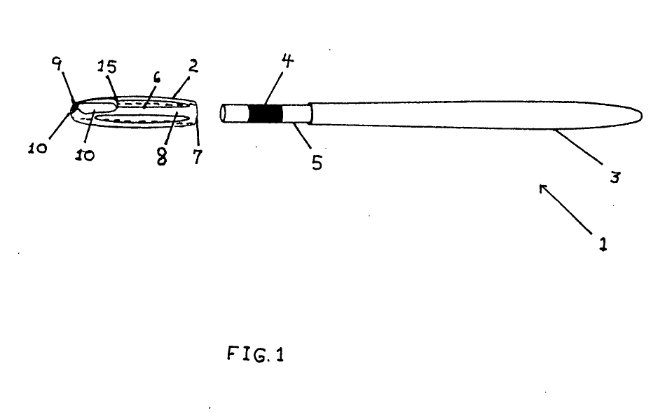

As illustrated in FIG. 1, the present holder has a handle 1 and a cap 2.

The handle 1 employs an elongated base 3 having a threaded projection 4 at a first end 5.

Preferably, the maximum outer diameter of the cap 2 is substantially the same as the maximum outer diameter of the elongated base 3.

The cap 2 contains a channel 6 extending through a first end 7 of the cap. The first portion 8 of the channel 6 is threaded for mating with the projection 4 of the elongated base 3. The second end 9 of the cap 2 contains an aperture 10 through which an endodontic file 11 can project.

In use, an endodontic file 11 is placed so that it extends through the aperture 10 with the plastic cap 12 that is attached to the endodontic file 11 (at an end 16 opposite to the tip 14) being in the channel 6. (The diameter of the aperture 10 is selected to be larger than the diameter of the endodontic file 11 but smaller than the diameter of the plastic cap 12.) The cap 2 is then screwed closer to the first end 5 of the elongated base 3 until the plastic cap 12 is securely retained in the channel 6 between the second end 9 of the cap 2 and the projection 4.

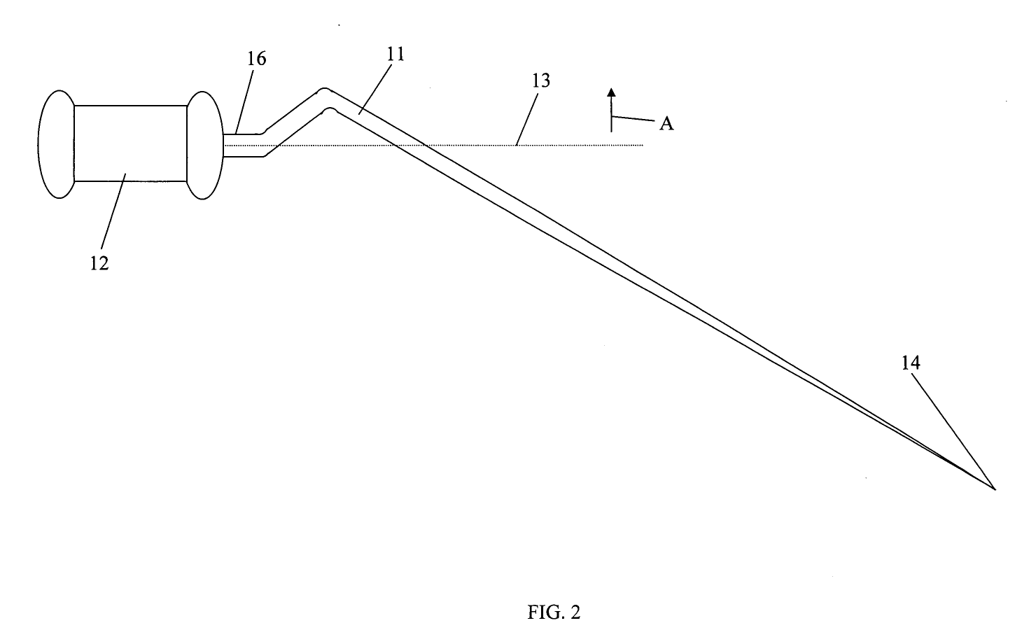

In order to facilitate the work of an endodontist, an option to the present invention is, as portrayed in FIG. 2, an endodontic file 11 that initially moves away from the centerline 13 of the endodontic file 11 in a first direction shown by the arrow A and then curves back toward and crosses the centerline 13 as the tip 14 of the endodontic file 11 is approached.

To accommodate such a bent endodontic file 11, the aperture 10 is extended to the side 15 of the cap 2 and, on such side 15, enlarged to dimensions sufficient to permit the introduction into the channel 6 of the plastic cap 12.

The Holder aids the dentist by changing the thumb-and-finger grip to a pencil-type grip, which is more suitable for manipulating the endodontic file 11. And the bent endodontic file 11 permits the dentist to place his or her hand in a more convenient location.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

1. An endodontic instrument, which comprises:
a handle having an elongated base with a threaded projection at a first end; and
a cap containing a channel extending through a first end of said cap with a first portion of the channel being threaded for mating with the projection of the elongated base of said handle, said cap possessing a side, and said cap also having a second end containing an aperture through which an endodontic file can project, the diameter of the aperture being selected to be larger than the diameter of the endodontic file but smaller that the diameter of a plastic cap attached to the endodontic file.

2. The endodontic instrument as recited in claim 1, wherein:
the elongated base has a maximum outer diameter;
said cap has a maximum outer diameter; and
the maximum outer diameter of said cap is substantially the same as the maximum outer diameter of the elongated base.

3. The endodontic instrument as recited in claim 1, further comprising:
an endodontic file with a tip and also with a plastic cap attached to said endodontic file at an end opposite to the tip, said endodontic file extending through the aperture in the second end of said cap and the attached plastic cap being contained within the channel of said cap.

4. The endodontic instrument as recited in claim 3, wherein:
the elongated base has a maximum outer diameter;
said cap has a maximum outer diameter; and
the maximum outer diameter of said cap is substantially the same as the maximum outer diameter of the elongated base.

5. The endodontic instrument as recited in claim 1, wherein:
the aperture in the second end of said cap extends to the side of said cap and, on such side, is enlarged to dimensions sufficient to permit the introduction in the channel of the plastic cap attached to the endodontic file.

6. The endodontic instrument as recited in claim 5, wherein:
the elongated base has a maximum outer diameter;
said cap has a maximum outer diameter; and
the maximum outer diameter of said cap is substantially the same as the maximum outer diameter of the elongated base.

7. The endodontic instrument as recited in claim 5, further comprising:
an endodontic file with a tip, with a centerline, and also with a plastic cap attached to said endodontic file at an end opposite to the tip, said endodontic file extending through the aperture in the second end of said cap and the attached plastic cap being contained within the channel of said cap and said endodntic file, as said endodontic file proceeds toward the tip, intitially moving away from the centerline and then curving back toward and crossing the centerline.

8. The endodontic instrument as recited in claim 7, wherein:
the elongated base has a maximum outer diameter;
said cap has a maximum outer diameter; and
the maximum outer diameter of said cap is substantially the same as the maximum outer diameter of the elongated base.

9. An endodontic instrument, which comprises:
a handle having an elongated base with the base possessing a threaded projection at a first end and a maximum outer diameter;
a cap containing a channel extending through a first end of said cap with a first portion of the channel being threaded for mating with the projection of the elongated base of said handle, said cap possessing a side, said cap having a maximum outer diameter that is substantially the same as the maximum outer diameter of the elongated base, and said cap also having a second end containing an aperture through which an endodontic file can project, the diameter of the aperture being selected to be larger than the diameter of the endodontic file but smaller that the diameter of a plastic cap attached to the endodontic file; and
an endodontic file with a tip and also with a plastic cap attached to said endodontic file at an end opposite to the tip, said endodontic file extending through the aperture in the second end of said cap and the attached plastic cap being contained within the channel of said cap.

10. An endodontic instrument, which comprises:
a handle having an elongated base with the base possessing a threaded projection at a first end and a maximum outer diameter;
a cap containing a channel extending through a first end of said cap with a first portion of the channel being threaded for mating with the projection of the elongated base of said handle, said cap possessing a side, said cap having a maximum outer diameter that is substantially the same as the maximum outer diameter of the elongated base, and said cap also having a second end containing an aperture through which an endodontic file can project, the diameter of the aperture being selected to be larger than the diameter of the endodontic file but smaller that the diameter of a plastic cap attached to the endodontic file; and
an endodontic file with a tip, with a centerline, and also with a plastic cap attached to said endodontic file at an end opposite to the tip, said endodontic file extending through the aperture in the second end of said cap and the attached plastic cap being contained within the channel of said cap and said endodntic file, as said endodontic file proceeds toward the tip, intitially moving away from the centerline and then curving back toward and crossing the centerline.
